(19) United States
(12) Patent Application Publication
(10) Pub. No.: US 2017/0243063 A1
(43) Pub. Date: Aug. 24, 2017

(54) AUTHENTICATION METHOD, ELECTRONIC DEVICE, AND STORAGE MEDIUM

(71) Applicant: FUJITSU LIMITED, Kawasaki-shi (JP)

(72) Inventors: Shuji KANEKO, Meguro (JP); Kota ARIYAMA, Kawasaki (JP); Hiroshi FUJINO, Fuchu (JP)

(73) Assignee: FUJITSU LIMITED, Kawasaki-shi (JP)

(21) Appl. No.: 15/435,219

(22) Filed: Feb. 16, 2017

(30) Foreign Application Priority Data
Feb. 22, 2016 (JP) 2016-031360

(51) Int. Cl. G06K 9/00; G06F 21/32; G06K 9/52; G06T 7/11; G06F 3/01; G06F 3/03

(52) U.S. Cl. CPC G06K 9/00617; G06F 3/013; G06F 3/0304; G06K 9/00335; G06K 9/0061; G06K 9/52; G06T 7/11; G06F 21/32; G06K 2009/4666

(57) ABSTRACT

An authentication method executed by a processor included in an electronic device, the authentication method includes setting a plurality of gaze points on a screen of the electronic device such that an order for the gaze points is determined; capturing a plurality of images of an eye at the gaze points, when the eye gazes at the gaze points according to the order; detecting an iris from each of the images of the eye; calculating an exposure amount of the iris in each of the images of the eye; and releasing restriction of operation on the electronic device, when it is determined that a pattern of the iris agrees with a previously registered template and the exposure amount of the iris agrees with a previously registered value.

### CROSS-REFERENCE TO RELATED APPLICATION

This application is based upon and claims the benefit of priority of the prior Japanese Patent Application No. 2016-031360, filed on Feb. 22, 2016, the entire contents of which are incorporated herein by reference.

### FIELD

The embodiments discussed herein are related to an authentication method, an electronic device, and a storage medium.

### BACKGROUND

A recent electronic device such as a smartphone or a cellular phone typically has a lock function by which the electronic device is locked to restrict input operations when a user does not operate the electronic device for a predetermined time, and is unlocked by a user authentication (personal authentication) operation when the user starts an input operation. This function restricts use of the electronic device unless the personal authentication is successful, and thereby reduces a risk of information leakage to a third person.

Recently, electronic devices that employ, as a personal authentication method, iris authentication by using the iris in a pupil have been widely used. The iris authentication is a method that authenticates a user by capturing an image of an eye of the user with a camera included in the electronic device, extracting an iris region from the captured image of the eye, and comparing the iris region to a previously registered iris template.

When an electronic device including a camera and a screen on the same surface employs the iris authentication to unlock the electronic device, the electronic device is unlocked when a user only gazes at the screen of the electronic device. This may cause a problem in that the electronic device is unlocked even when the user does not want to unlock the electronic device. To solve such a problem, there has been disclosed a related art that performs the iris authentication in combination with authentication with eye-gaze detection. The eye-gaze detection in the related art is performed by detecting motion of an eye. Examples of the related art include Japanese Laid-open Patent Publication No. 11-339037 and Japanese National Publication of International Patent Application 2008-516339.

However, when the user is using the electronic device, the eye of the user is not squarely in front of the electronic device. For example, the user operates the electronic device while facing downward in some cases. In such a case, the user is looking down at the electronic device, and the top lid and the bottom lid are covering upper and lower parts of the iris. Thus, when the eye of the user is not squarely in front of the electronic device, a top-to-bottom length of the eye exposed to outside is shorter than when the eye is squarely in front of the electronic device, which may lower the accuracy of the iris authentication.

For this reason, the electronic device is desirably capable of performing personal authentication at high accuracy irrespective of a positional relation between the user and the electronic device.

### SUMMARY

According to an aspect of the invention, an authentication method executed by a processor included in an electronic device, the authentication method includes setting a plurality of gaze points on a screen of the electronic device such that an order for the gaze points is determined; capturing a plurality of images of an eye at the gaze points, when the eye gazes at the gaze points according to the order; detecting an iris from each of the images of the eye; calculating an exposure amount of the iris in each of the images of the eye; and releasing restriction of operation on the electronic device, when it is determined that a pattern of the iris agrees with a previously registered template and the exposure amount of the iris agrees with a previously registered value.

The object and advantages of the invention will be realized and attained by means of the elements and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 is an exemplary functional block diagram of an electronic device in a first embodiment;

FIG. 2 is a diagram illustrating an exemplary hardware configuration of the electronic device;

FIG. 3 is an exemplary front view of the electronic device;

FIG. 4 is a diagram illustrating an exemplary movement pattern;

FIGS. 5A and 5B are diagrams illustrating a positional relation between an eye and the electronic device;

FIG. 6A is a first diagram for description of a state change of the eye during an eye gaze movement;

FIG. 6B is a second diagram for description of a state change of the eye during an eye gaze movement;

FIG. 7 is a first flowchart of an exemplary method of registering authentication information in the first embodiment;

FIG. 8 is a diagram illustrating an exemplary setting image at registration of authentication information at step S101;

FIG. 9 is a second flowchart of the exemplary method of registering authentication information in the first embodiment;

FIG. 10 is a diagram illustrating an exemplary display image at step S105;

FIG. 11 is a third flowchart of the exemplary method of registering authentication information in the first embodiment;

FIG. 12 is a first flowchart of an exemplary authentication method in the first embodiment;

FIG. 13 is a second flowchart of the exemplary authentication method in the first embodiment;

FIG. 14 is an exemplary functional block diagram of an electronic device in a second embodiment;

FIG. 15 is a flowchart of an exemplary method of registering authentication information in the second embodiment;

FIG. 16 is a diagram illustrating an exemplary profile of change in the number of feature points;

FIG. 17 is a flowchart of an exemplary authentication method in the second embodiment;

FIG. 18 is an exemplary functional block diagram of an electronic device in a third embodiment;

FIG. 19 is a flowchart of an exemplary method of registering authentication information in the third embodiment; and

FIG. 20 is a flowchart of an exemplary authentication method in the third embodiment.

### DESCRIPTION OF EMBODIMENTS

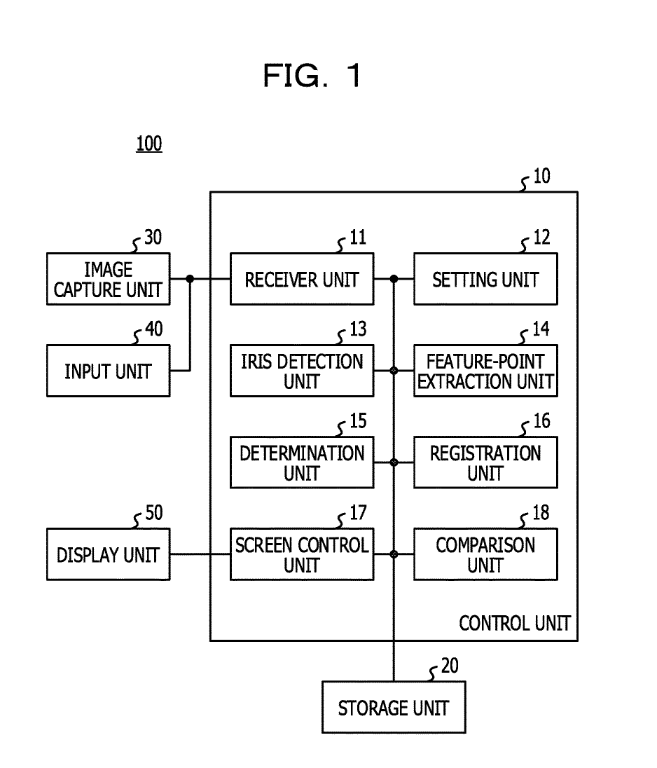

Embodiments of the present disclosure will be described below in detail with reference to FIGS. 1 to 20.

### First Embodiment

FIG. 1 is an exemplary functional block diagram of an electronic device in a first embodiment. As illustrated in FIG. 1, this electronic device 100 includes a control unit 10, a storage unit 20, an image capture unit 30, an input unit 40, and a display unit 50. The following describes a function of each component.

The control unit 10 is hardware that manages processing of the entire electronic device 100. The control unit 10 includes a receiver unit 11, a setting unit 12, an iris detection unit 13, a feature-point extraction unit 14, a determination unit 15, a registration unit 16, a screen control unit 17, and a comparison unit 18.

The receiver unit 11 receives an image of an eye of a user captured by the image capture unit 30. The receiver unit 11 receives various kinds of commands from the user through the input unit 40.

The setting unit 12 executes various kinds of setting processing. For example, the setting unit 12 sets a pattern including multiple points on a screen of the display unit 50 such that an order for the user to gaze at the points during authentication (also simply referred to as a gazing order below) is determined. Hereinafter, the points on the screen at which the user has to gaze are referred to as “gaze points”. A pattern including multiple gaze points is referred to as a “movement pattern”.

The iris detection unit 13 detects an iris from the image of the eye received from the receiver unit 11. The iris is a membrane between a cornea and a lens. The iris is, in a colored region, a ring-shaped part outside of a pupil at the center of the colored region.

The feature-point extraction unit 14 extracts multiple feature points from the detected iris. The extracted feature points constitute a pattern of the iris unique to each person. In addition, the feature-point extraction unit 14 has a function to count the number of feature points as an exposure amount of the iris. The feature-point extraction unit 14 is an exemplary calculation unit.

The determination unit 15 executes various kinds of determination processing performed by the electronic device 100. The determination unit 15 determines whether the pattern of the iris detected by the iris detection unit 13 agrees with a previously registered template. The determination unit 15 determines whether a change in the exposure amount of the iris when the user gazes at the gaze points on the screen according to the predetermined order agrees with the previously registered template.

The registration unit 16 executes processing of registering various kinds of templates of the iris used for authentication.

The screen control unit 17 executes control on the screen of the display unit 50. For example, the screen control unit 17 executes control of displaying a predetermined image on the screen of the display unit 50 or control to switch display contents. The screen control unit 17 controls the display unit 50 to unlock the electronic device 100 based on a result of the determination by the determination unit 15.

The comparison unit 18 compares the pattern of the iris detected by the iris detection unit 13 to the previously registered template. In a second embodiment to be described later, the comparison unit 18 compares, to the previously registered template, a profile indicating a change in the exposure amount of the iris when the user gazes at the gaze points on the screen according to the predetermined order.

The following describes the storage unit 20, the image capture unit 30, the input unit 40, and the display unit 50 connected with the control unit 10.

The storage unit 20 is hardware that stores therein information and a computer program used in processing executed by the control unit 10. For example, the storage unit 20 stores therein various kinds of templates of the iris used for authentication. The storage unit 20 may include two or more storage devices in accordance with a usage or a requested storage capacity.

The image capture unit 30 captures an image of the eye of the user used to detect the iris. The image capture unit 30 captures an image of the eye at each gaze point when the user gazes at the gaze points on the screen according to the predetermined order. The image capture unit 30 transmits the captured image of the eye to the receiver unit 11 of the control unit 10.

The input unit 40 is an input interface that receives input of each command from the user. The input unit 40 transmits the command from the user to the receiver unit 11.

The display unit 50 is connected with the screen control unit 17 and capable of displaying an image in accordance with control by the screen control unit 17.

The following describes a hardware configuration of the electronic device 100.

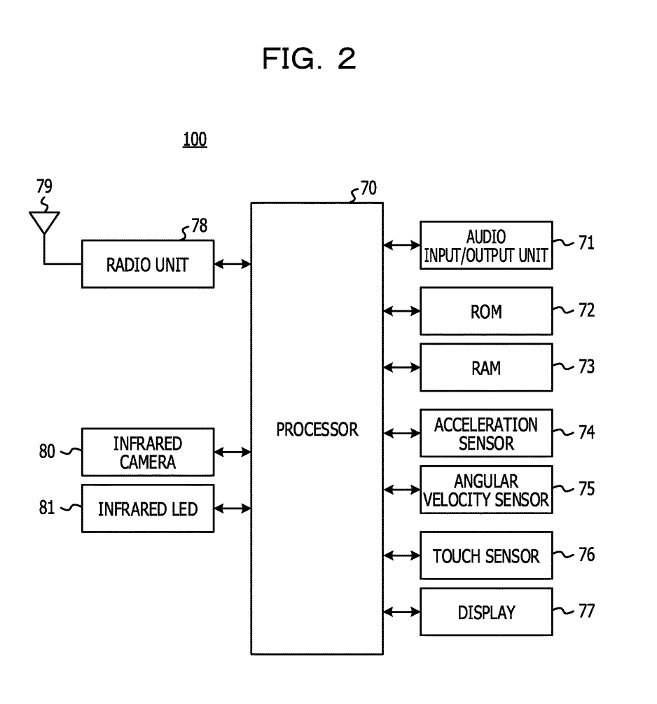

FIG. 2 is a diagram illustrating an exemplary hardware configuration of the electronic device. As illustrated in FIG. 2, the electronic device 100 includes a processor 70, an audio input/output unit 71, a read-only memory (ROM) 72, a random access memory (RAM) 73, an acceleration sensor 74, an angular velocity sensor 75, a touch sensor 76, a display 77, a radio unit 78, an antenna 79, an infrared camera 80, and an infrared LED 81.

The processor 70 is an arithmetic processing device that executes processing of controlling operation of the entire electronic device 100. The processor 70 may be achieved by, for example, a central processing unit (CPU) or a micro processing unit (MPU). The processor 70 is an exemplary control unit 10 illustrated in FIG. 1.

The audio input/output unit 71 includes, for example, an audio input device such as a microphone and an audio output device such as a speaker. For example, when the electronic device 100 is a cellular phone such as a smartphone capable of making a phone call, the audio input/output unit 71 receives input of a voice message by the user and outputs listening sound.

The ROM 72 is a non-transitory storage device that may store therein a computer program (including an information processing program) that controls operation of the electronic device 100. The RAM 73 is a transitory storage device that may be used as a work area to execute a computer program. The RAM 73 may be provided inside the processor 70. The ROM 72 and the RAM 73 are examples of a storage unit 20 illustrated in FIG. 1.

The acceleration sensor 74 is a device for measuring the acceleration of the electronic device 100. The angular velocity sensor 75 is a device for measuring the angular velocity of the electronic device 100. The acceleration sensor 74 and the angular velocity sensor 75 are used as sensors for detecting the position and posture of the electronic device 100.

The touch sensor 76 is an input device for operating the electronic device 100 by making, for example, a finger contact with an operation surface. The touch sensor 76 may be disposed to cover the display 77 to be described later, for example. The touch sensor 76 is an exemplary input unit 40 illustrated in FIG. 1.

The display 77 is a device for displaying an image. The display 77 is achieved by, for example, a liquid crystal display, a plasma display, or an organic EL display. The display 77 is an exemplary display unit 50 illustrated in FIG. 1.

The radio unit 78 is hardware that receives a signal through the antenna 79 and outputs the received signal to the processor 70. The radio unit 78 transmits, through the antenna 79, a signal generated by the processor 70. The radio unit 78 communicates signals of a voice message of the user, listening sound, and the like, for example, when the electronic device 100 is a cellular phone.

The infrared camera 80 is an instrument for capturing an image of the eye of the user used to detect of the iris. The infrared camera 80 is an exemplary image capture unit 30 illustrated in FIG. 1.

The infrared LED 81 is an electric component for emitting infrared. The electronic device 100 captures an image of the eye of the user by using both the infrared camera 80 and the infrared LED 81 simultaneously. The emission of infrared by the infrared LED 81 minimizes reflection of light from the cornea, since the reflection is an impediment to image recognition of the pattern of the iris. In addition, the use of infrared enables iris authentication at a dark place.

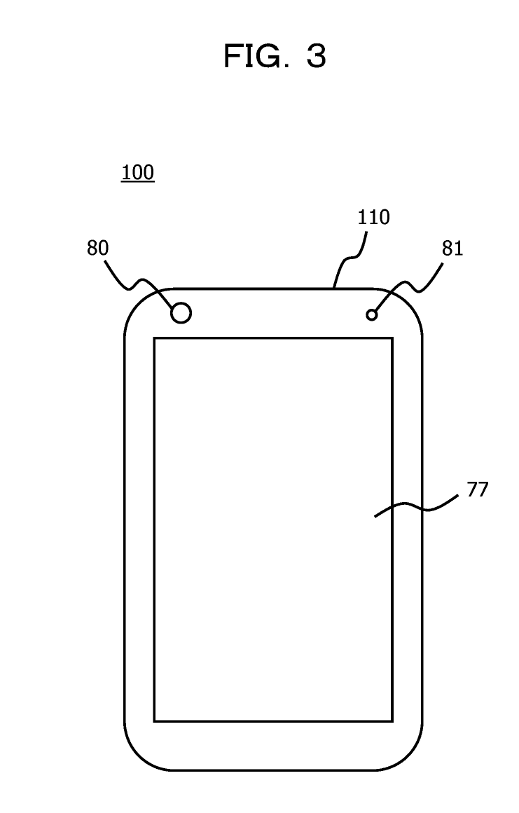

FIG. 3 is an exemplary front view of the electronic device. Any component identical to that illustrated in FIG. 2 is denoted by an identical reference sign. As illustrated in FIG. 3, the electronic device 100 includes a body 110, the display 77, the infrared camera 80, and the infrared LED 81.

The display 77 is disposed to be exposed from an upper surface of the body 110, and displays, for example, an image, an icon, and text. The infrared camera 80 and the infrared LED 81 are disposed separately from each other on an upper side of the display 77. In this manner, the display 77, the infrared camera 80, and the infrared LED 81 are mounted on the same surface of the electronic device 100.

The electronic device 100 according to the present embodiment may execute two methods: a method of performing iris authentication combined with eye-gaze detection, and a method of performing iris authentication without the eye-gaze detection. The former method performs iris authentication with the eye gaze moved in accordance with a predetermined movement pattern, and is also referred to as “pattern iris authentication”. The latter method is also referred to as “iris authentication” later. The movement pattern is a route including the gaze points, along which the eye gaze is to move on the display 77.

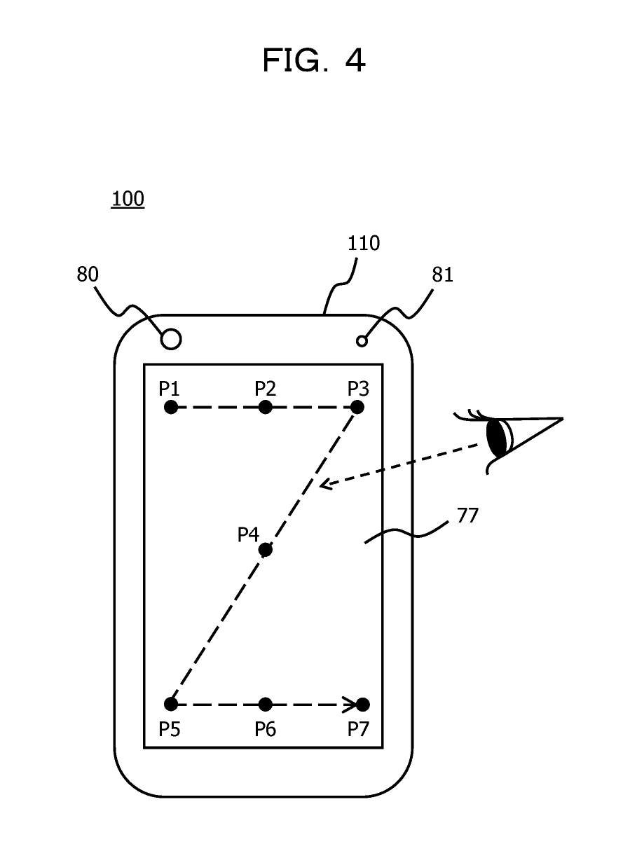

FIG. 4 is a diagram illustrating an exemplary movement pattern.

The dotted arrow drawn in the region of the display 77 illustrates the movement pattern of the eye gaze. The upper-left gaze point of the movement pattern is denoted by P1, the upper central gaze point is denoted by P2, the upper-right gaze point is denoted by P3, the central gaze point is denoted by P4, the lower-left gaze point is denoted by P5, the lower central gaze point is denoted by P6, and the lower-right gaze point is denoted by P7. An ordinary number in the gazing order is allocated to each gaze point included in the movement pattern. When registering an authentication template, the user moves the eye while gazing at P1, P2, P3, P4, P5, P6, and P7 in turn in this order. As the eye moves along the movement pattern, the exposure amount of the iris when viewed from the infrared camera 80 changes.

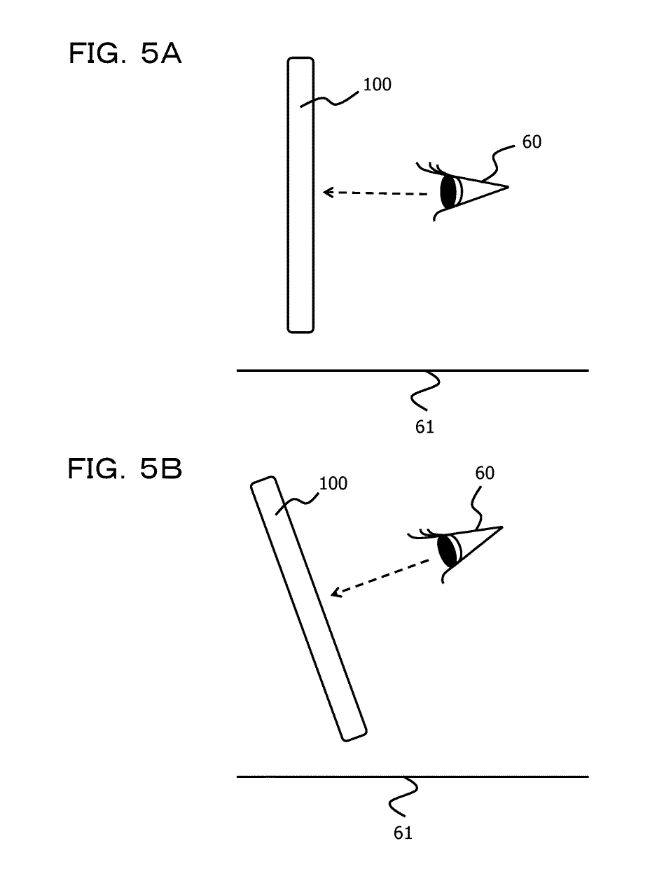

FIGS. 5A and 5B are diagrams illustrating a positional relation between the eye and the electronic device. FIG. 5A is a diagram illustrating a case in which an eye 60 is squarely in front of the electronic device 100, and FIG. 5B is a diagram illustrating a case in which the eye 60 is not squarely in front of the electronic device 100.

As illustrated in FIG. 5A, when the eye 60 is squarely in front of the electronic device 100, the user sees the electronic device 100 with the eye gaze approximately perpendicular to the electronic device 100 and parallel to a ground 61. As illustrated in FIG. 5B, when the eye 60 is not squarely in front of the electronic device 100, the user sees the electronic device 100 with the eye gaze approximately perpendicular to the electronic device 100 and not parallel to the ground 61.

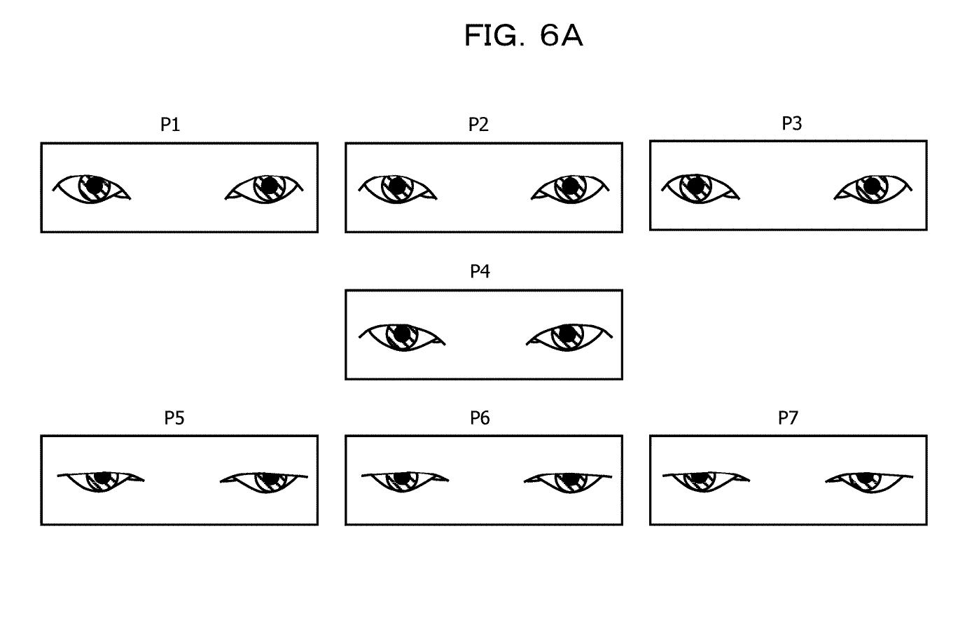

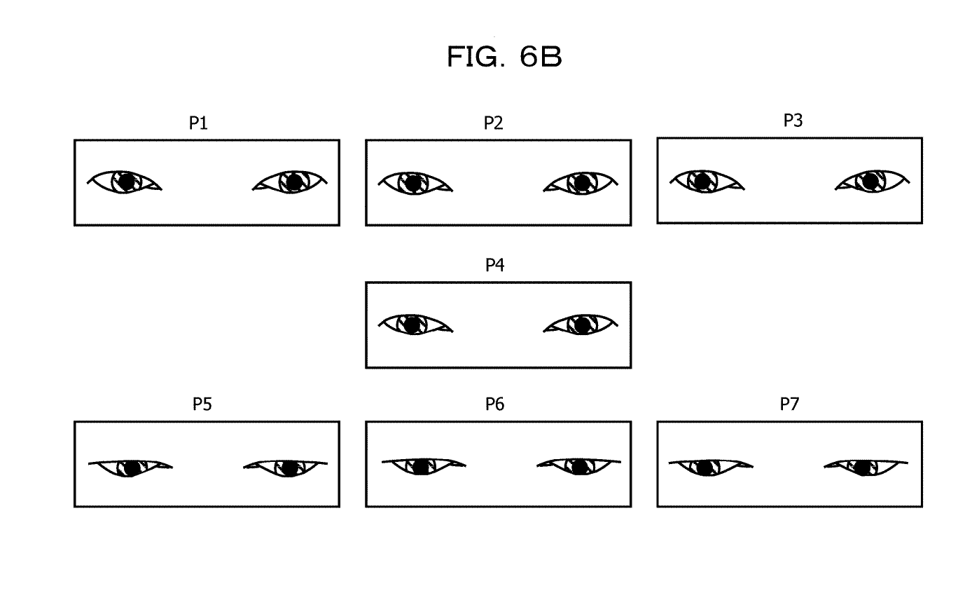

FIGS. 6A and 6B are diagrams each illustrating a state change of the eye during an eye movement. FIGS. 6A and 6B each illustrate the state change of the eye 60 during the eye gaze movement along the movement pattern of the eye gaze illustrated in FIG. 4. In FIGS. 6A and 6B, a hatched part illustrates the iris. FIG. 6A illustrates the states of the eye when the eye gaze is pointed to the gaze points P1, P2, P3, P4, P5, P6, and P7 with the eye 60 located squarely in front of the electronic device 100. FIG. 6B illustrates the states of the eye when the eye gaze is pointed to the gaze points P1, P2, P3, P4, P5, P6, and P7 with the eye 60 not located squarely in front of the electronic device 100.

When the eye 60 is squarely in front of the electronic device 100, as illustrated in FIG. 6A, an upper part of the iris is hidden by the top lid but a lower part of the iris is not hidden by the bottom lid while the eye gaze moves from P1 to P3 through P2. The exposure amount of the iris changes little from P1 to P3. However, as the eye gaze moves from P3 to P5 through P4, the top lid and the bottom lid gradually become closed, and the lower part of the iris starts being hidden by the bottom lid. The exposure amount of the iris decreases along with such a change of the lids. Thereafter, while the eye gaze moves from P5 to P7 through P6, the closing motion of the lids is substantially stopping, and the exposure amount of the iris changes little.

When the eye 60 is not squarely in front of the electronic device 100, as illustrated in FIG. 6B, the exposure amount of the iris changes little while the eye gaze moves from P1 to P3 through P2. However, the eye 60 is open narrower than when the eye 60 is squarely in front of the electronic device 100, and thus the exposure amount of the iris is smaller than when the eye 60 is squarely in front of the electronic device 100. The upper part of the iris is hidden by the top lid, and the lower part of the iris is hidden by the bottom lid. While the eye gaze moves from P3 to P5 through P4, and in addition, from P5 to P7 through P6, the change in the exposure amount of the iris has the same tendency as that illustrated in FIG. 6A. However, the exposure amount of the iris is still smaller than when the eye 60 is squarely in front of the electronic device 100, and in particular, the exposure amount of the iris has significant decreases in the lower part.

The following describes an authentication method executed by the electronic device 100 illustrated in FIG. 1 in the first embodiment.

In the present embodiment, the iris authentication is performed in combination with authentication with the eye-gaze detection. Thus, a template of the pattern of the iris (distribution of feature points) and a template of the change profile in the exposure amount of the iris are previously registered before execution of the iris authentication.

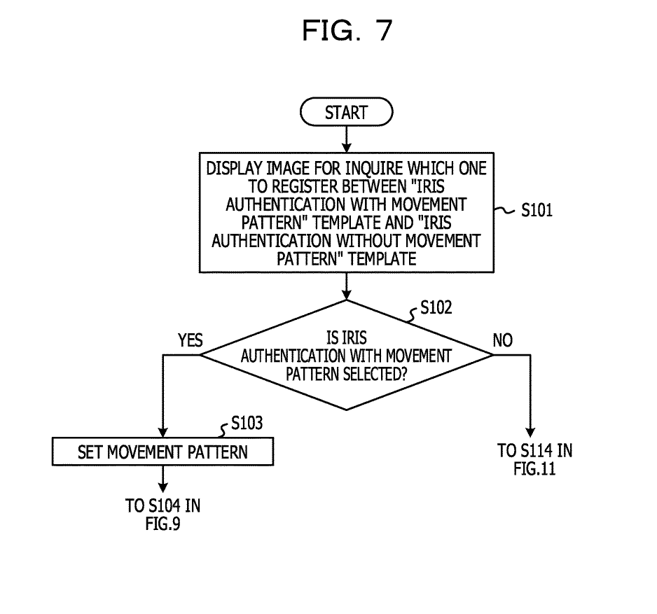

The following describes a method of the registration with reference to FIGS. 7 to 11.

FIG. 7 is a first flowchart of an exemplary method of registering authentication information in the first embodiment.

As described above, the electronic device 100 according to the present embodiment may execute the two kinds of methods, the “iris authentication with the movement pattern” and the “iris authentication without the movement pattern”. First, in response to a registration instruction received from the user, the screen control unit 17 displays, on the screen of the display unit 50, an image for inquiring the user which template to register between templates for the two methods (step S101).

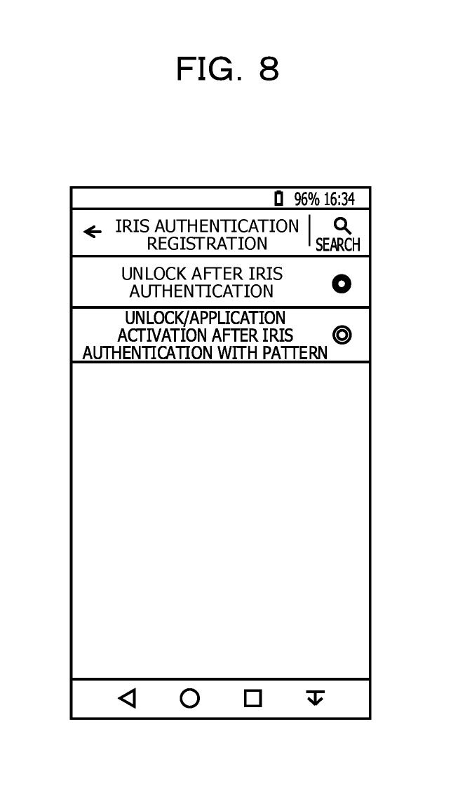

FIG. 8 is a diagram illustrating an exemplary setting image at the registration of the authentication information at step S101. As illustrated in FIG. 8, options of “UNLOCK AFTER IRIS AUTHENTICATION” and “UNLOCK/APPLICATION ACTIVATION AFTER IRIS AUTHENTICATION WITH PATTERN” are displayed to allow the user to select one of the options. FIG. 8 illustrates a screen displayed when “UNLOCK AFTER IRIS AUTHENTICATION” is selected and light is on at the right end of the option.

In FIG. 7, after the processing at step S101, the determination unit 15 determines whether the iris authentication with the movement pattern is selected (step S102). At step S102, the determination unit 15 determines that the pattern iris authentication is selected when the user operates the input unit 40 to input a selection of the iris authentication with the movement pattern. In the example illustrated in FIG. 8, the determination unit 15 determines that the iris authentication with the movement pattern is selected when the user selects “UNLOCK/APPLICATION ACTIVATION AFTER IRIS AUTHENTICATION WITH PATTERN”.

The determination unit 15 determines that the pattern iris authentication is not selected when the user operates the input unit 40 to input a selection of the iris authentication without the movement pattern. In the example illustrated in FIG. 8, the determination unit 15 determines that the iris authentication with the movement pattern is not selected and the iris authentication without the movement pattern is selected when the user selects “UNLOCK AFTER IRIS AUTHENTICATION”.

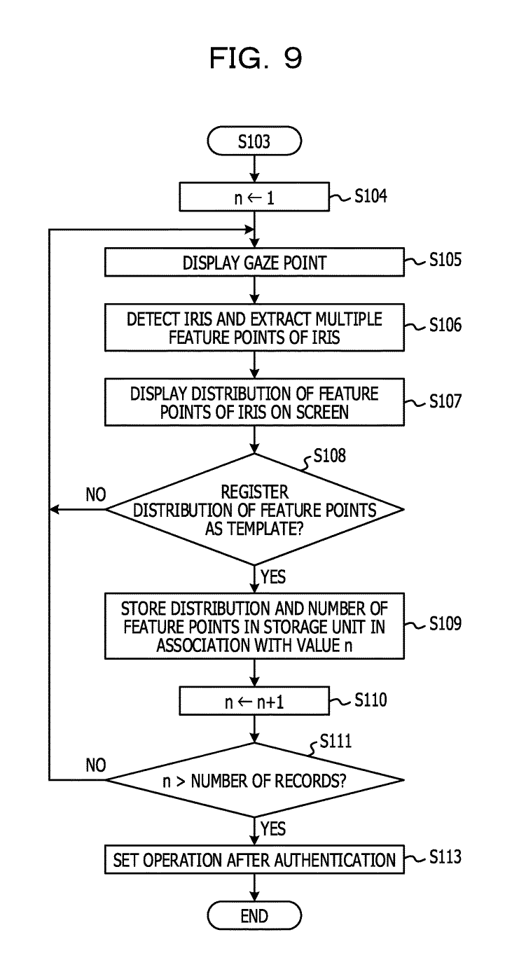

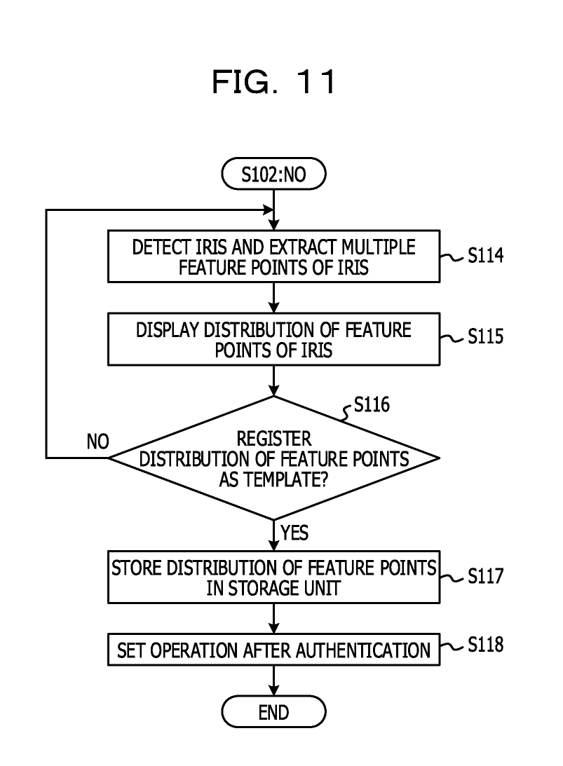

If the determination unit 15 determines that the iris authentication with the movement pattern is selected (Yes at step S102), the setting unit 12 sets a movement pattern used at registration of an authentication template (step S103). At step S103, for example, the user operates the input unit 40 to input information including the positions of multiple gaze points to be set on the movement pattern and a gazing order. Then, the setting unit 12 sets the inputted information as a movement pattern. The setting unit 12 may count the number of gaze points (the number of records) by receiving the positions of multiple feature points, and thus may set the number of records as well. In addition, when the order in which the positions of the gaze points are inputted by the user is set to be the gazing order for the user, the user may omit the processing of inputting the order information. Thereafter, the process proceeds to step S104 illustrated in FIG. 9. If the determination unit 15 determines that the pattern iris authentication is not selected (No at step S102), the process proceeds to step S114 illustrated in FIG. 11.

FIG. 9 is a second flowchart of the exemplary method of registering the authentication information in the first embodiment. After the setting of the movement pattern at step S103, processing of registering of multiple authentication templates is executed by using the movement pattern thus set.

First, the setting unit 12 stores 1 in n (step S104). The value n is a sequence number indicating the order of the gaze points on the movement pattern.

Subsequently, the screen control unit 17 displays a gaze point on the movement pattern on the screen of the display unit 50 (the display 77) with the intention of causing the user to gaze at the gaze point (step S105). Specifically, the screen control unit 17 displays a gaze point associated with the value n on the screen. In the present embodiment, as the movement pattern of the eye gaze, the four gaze points P1, P3, P5, and P7 are set in association with their respective ordinary numbers in the gazing order in advance. Then, the electronic device 100 performs authentication by using information on the iris acquired when the user is gazing at each gaze point according to the order. The number of records is set to be four in advance. Settings of the movement pattern of the eye gaze, the gaze points, the gazing order, and the number of records may be changed by the user as appropriate.

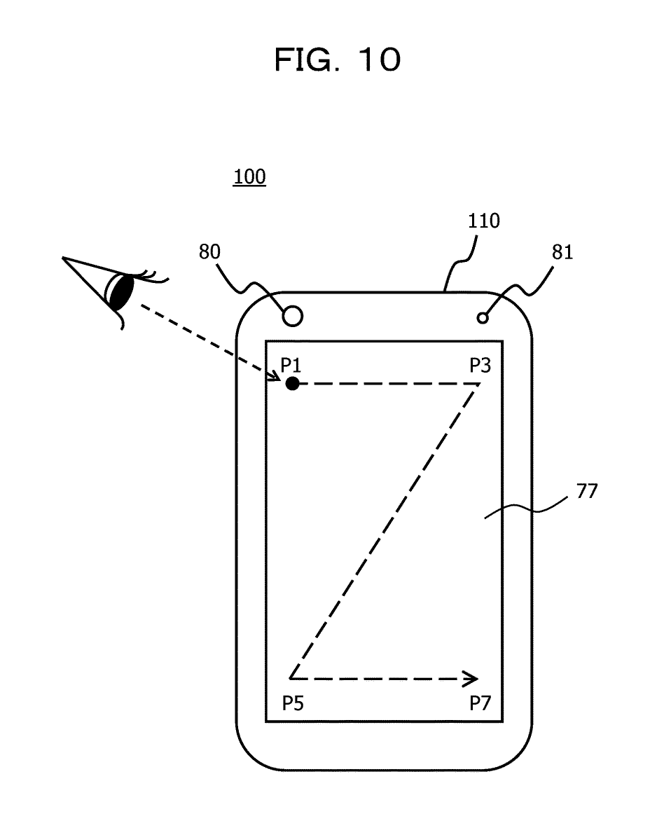

FIG. 10 is a diagram illustrating an exemplary display image at step S105. As illustrated in FIG. 10, when n=1, the screen control unit 17 displays, on the screen of the display 77, the gaze point P1 on the movement pattern. Simultaneously, the screen control unit 17 may display, on the screen, a text message for prompting the user to see the gaze point. Alternatively, the screen control unit 17 may output a sound message through the audio input/output unit 71 to prompt the user to see the gaze point.

As illustrated in FIG. 10, the screen control unit 17 may display the movement pattern together with the gaze points. This displaying method allows the user to know in advance the position of a point at which the user has to gaze next, which facilitates the gazing action by the user, thereby achieving improved convenience. When edge points of the movement pattern are selected as gaze targets like the four gaze points P1, P3, P5, and P7 as described above, the user may easily predict the position of a point at which the user gazes next, while performing a registration operation.

In FIG. 9, after the processing at step S105, while the user is seeing the gaze point displayed on the screen, the image capture unit 30 captures an image of the eye of the user and acquires image information. Thereafter, the iris detection unit 13 detects an iris from the acquired image information. Then, the feature-point extraction unit 14 extracts multiple feature points from the pattern of the iris (step S106). The feature points of the iris may be extracted by using the existing well-known method such as the technique Harris or the KLT technique. In the present embodiment, distribution of the extracted feature points is used for the iris authentication. The feature-point extraction unit 14 may count the number of feature points by extracting the feature points. This number of feature points is used, at authentication processing, as an index indicating the degree of the exposure amount of the iris when the eye is viewed by the infrared camera 80. Specifically, a larger number of feature points are counted as the iris has a larger exposed region.

Subsequently, the screen control unit 17 displays the distribution of the feature points of the iris on the screen of the display unit 50 (step S107). At step S107, for example, text, sound, or both of text and sound are used to prompt the user to select whether to register the distribution of the feature points as a template. Then, the determination unit 15 determines whether to register the distribution of the feature points as a template based on information input by the user through the input unit 40 (step S108). If it is determined not to register the distribution of the feature points as a template (No at step S108), the process returns to step S105 to execute again the processing at step S105 and later. If it is determined to register the distribution of the feature points as a template (Yes at step S108), the registration unit 16 stores the distribution and number of the feature points in the storage unit 20 in association with the value n (step S109). In this manner, the distribution and number of the feature points are registered in the storage unit 20 in advance.

Subsequently, the setting unit 12 sets the new value n to a value obtained by adding 1 to the old n (step S110).

Subsequently, the determination unit 15 determines whether the updated value n is larger than the number of records set in advance at step S103 (step S111). If it is determined by the determination unit 15 that the value n is not larger than the number of records (No at step S111), the process returns to step S105 to execute again the processing at step S105 and later so as to continuously acquire new information on the iris. If it is determined that the value n is larger than the number of records (Yes at step S111), the setting unit 12 sets operation after authentication (step S113). At step S113, the setting unit 12 sets whether to activate an application after unlock. If an application is to be activated, the setting unit 12 sets the type of an application to be activated. Upon completion of the processing at step S113, this series of processing to register multiple authentication templates ends.

The following describes processing of registering the authentication information, which is executed when it is determined that the iris authentication with the movement pattern is not selected in the processing at step S102 illustrated in FIG. 7.

FIG. 11 is a third flowchart of the exemplary method of registering the authentication information in the first embodiment. When No at step S102, the process transitions to processing of registering one kind of an authentication template.

First, the image capture unit 30 captures an image of the eye of the user gazing at a gaze point on the screen and acquires image information. Subsequently, the iris detection unit 13 detects an iris from the acquired image information, and extracts multiple feature points of the iris (step S114). At step S114, the iris detection unit 13 extracts the feature points of the iris from the image of the eye by using, for example, the existing well-known iris recognition algorithm. The processing executed at step S114 is same as the processing executed at step S106.

Subsequently, the screen control unit 17 displays the distribution of the feature points of the iris on the screen of the display unit 50 (step S115). At step S115, similarly to step S107, for example, text, sound, or both of text and sound are used to prompt the user to select whether to register the distribution of the feature points as a template. Then, the determination unit 15 determines whether to register the distribution of the feature points as a template based on information input by the user through the input unit 40 (step S116). If it is determined not to register the distribution of the feature points as a template (No at step S116), the process returns to step S114 to execute again the processing at step S114 and later. If it is determined to register the distribution of the feature points as a template (Yes at step S116), the registration unit 16 stores the distribution of the feature points in the storage unit 20 (step S117).

Subsequently, the setting unit 12 sets operation after authentication (step S118). The processing executed at step S118 is same as the processing executed at step S113. Upon completion of the processing at step S118, this series of processing to register the authentication information ends.

The following describes the authentication processing in the first embodiment.

The authentication processing is started when the receiver unit 11 receives, from the user, a command instructing start of the authentication processing. For example, the receiver unit 11 receives, from the user, the command instructing start of the authentication processing, through detection of the eye gaze of the user by the image capture unit 30, detection of a press on a button (not illustrated) included in the electronic device 100, or detection of contact with an icon displayed on the screen of the display unit 50.

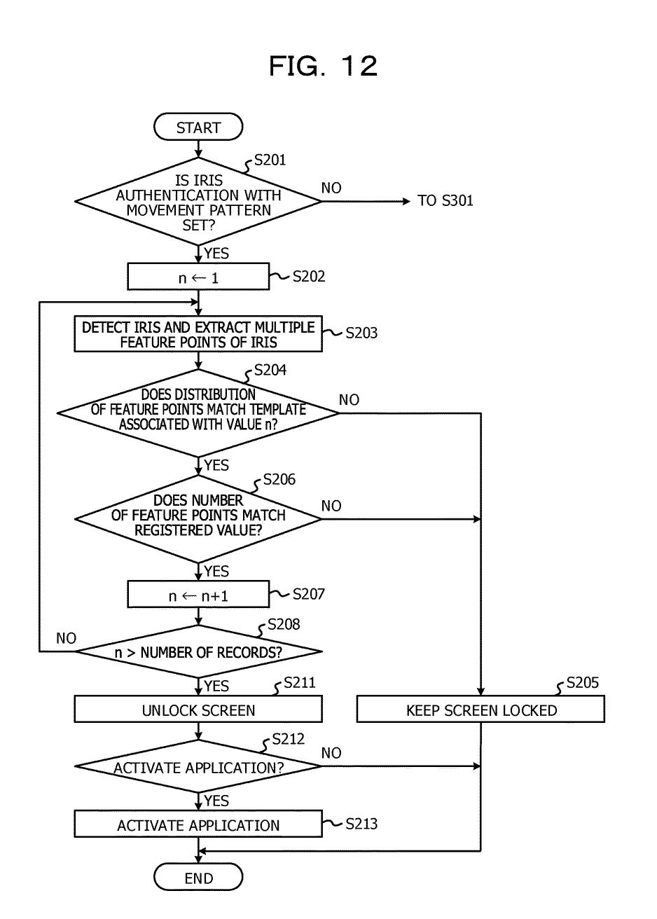

FIG. 12 is a first flowchart of an exemplary authentication method in the first embodiment.

First, in response to the reception of the command instructing start of the authentication processing from the user, the determination unit 15 determines whether the iris authentication with the movement pattern is set (step S201). If the iris authentication with the movement pattern is not set (No at step S201), the process proceeds to step S301. The processing at step S301 and later will be described later. If the iris authentication with the movement pattern is set (Yes at step S201), the setting unit 12 stores 1 in n (step S202). The value n is used as a sequence number indicating the number of times that the iris authentication is executed.

Subsequently, the user moves the eye gaze to a position at a gaze point on the screen of the display unit 50. In this case, a gaze point associated with the value n is not displayed on the screen. During this time, the image capture unit 30 captures an image the eye of the user and acquires image information. Thereafter, the iris detection unit 13 detects an iris from the acquired image information. Then, the feature-point extraction unit 14 extracts multiple feature points from the pattern of the iris (step S203). A method of extracting the feature points may be, for example, the method used in the processing at step S106.

Subsequently, the determination unit 15 determines whether the distribution of the feature points extracted by the feature-point extraction unit 14 matches a previously registered template of the distribution of the feature points associated with the value n (step S204). If it is determined that the extracted distribution of the feature points does not match the template of the distribution of the feature points associated with the value n (No at step S204), it is determined that personal authentication has failed, and the screen control unit 17 keeps the screen locked (step S205). Then, the electronic device 100 ends this series of the authentication processing.

If it is determined that the extracted distribution of the feature points matches the template of the distribution of the feature points associated with the value n (Yes at step S204), it is determined that the iris authentication has been successful, and subsequently, the determination unit 15 determines whether the number of feature points matches a previously registered value of the number of feature points (step S206). At step S206, if the number of feature points is not exactly equal to, but is practically nearly equal to the registered value, it is determined that they match each other. For example, it is determined that they match each other if a difference between these values is within a predetermined range.

If it is determined that the number of feature points does not match the registered value of the number of feature points (No at step S206), it is determined that personal authentication has failed, and the screen control unit 17 keeps the screen locked (step S205). Then, the electronic device 100 ends this series of the authentication processing. If it is determined that the number of feature points matches the registered value of the number of feature points (Yes at step S206), it is determined that n-th personal authentication has been successful. Then, the setting unit 12 sets a new value n to be a value obtained by adding one to the old value n (step S207).

Subsequently, the determination unit 15 determines whether the updated value n is larger than the number of records set in advance (step S208). If it is determined by the determination unit 15 that the value n is not larger than the number of records (No at step S208), the process returns to step S203 to execute again the processing at step S203 and later so as to continuously execute new iris authentication. If it is determined that the value n is larger than the number of records (Yes at step S208), it is determined that personal authentication has been successful n times, and the screen is unlocked (step S211).

Subsequently, the determination unit 15 determines whether to activate an application (step S212). The determination unit 15 determines whether to activate an application by checking whether an application is set to be activated after unlock. If an application is set to be activated whenever the pattern iris authentication is performed or whenever the screen is unlocked, the determination processing at step S212 may be omitted.

At step S212, if it is determined that an application is not to be activated (No at step S212), the electronic device 100 ends this series of the authentication processing. If it is determined that an application is to be activated (Yes at step S212), the screen control unit 17 activates, in accordance with the content of setting, a predetermined application to be executed after unlock (step S213). Then, the electronic device 100 ends processing of the iris authentication with the movement pattern.

The following describes processing of the iris authentication without the movement pattern.

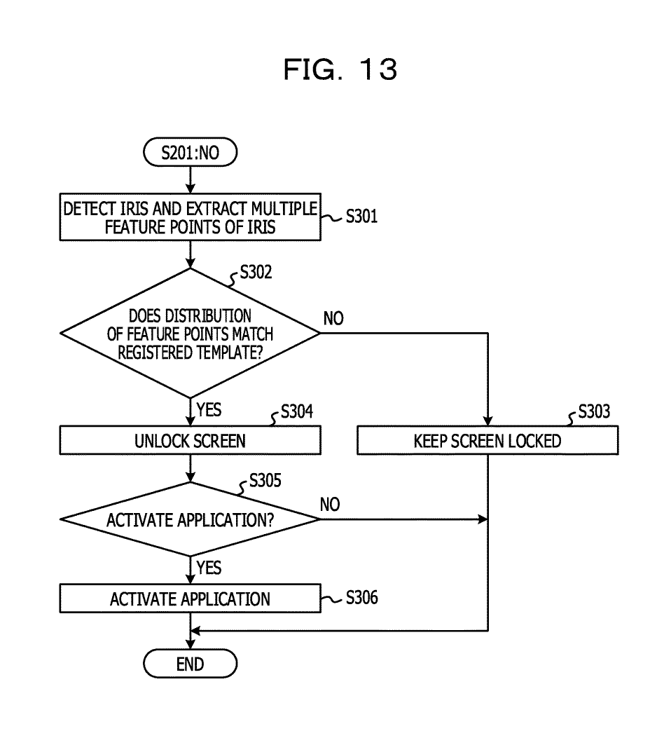

FIG. 13 is a second flowchart of an exemplary authentication method in the first embodiment. When No at step S201, the processing of the iris authentication without the movement pattern is started.

First, the screen control unit 17 displays a predetermined gaze point to prompt the user to gaze at. This predetermined gaze point is a default gaze point set in advance and used in the iris authentication without the movement pattern. While the user is gazing at the predetermined gaze point, the image capture unit 30 captures an image of the eye and acquires image information. Thereafter, the iris detection unit 13 detects an iris from the acquired image information. Then, the feature-point extraction unit 14 extracts multiple feature points from the pattern of the iris (step S301).

Subsequently, the determination unit 15 determines whether the distribution of the feature points extracted by the iris detection unit 13 matches a previously registered template of the distribution of the feature points (step S302). If it is determined the distribution of the feature points does not match the template (No at step S302), it is determined that personal authentication has failed, and the screen control unit 17 keeps the screen locked (step S303). Then, the electronic device 100 ends this series of the authentication processing.

If it is determined the distribution of the feature points matches the template (Yes at step S302), it is determined that personal authentication has been successful, and the screen control unit 17 unlocks the screen (step S304).

Subsequently, the determination unit 15 determines whether to activate an application (step S305). The processing at step S305 is substantially same as the processing at step S212 illustrated in FIG. 12, and similarly to step S212, the determination processing at step S305 may be omitted depending on the content of setting. At step S305, if it is determined an application is not to be activated (No at step S305), the electronic device 100 ends this series of the authentication processing. If it is determined an application is to be activated (Yes at step S305), the screen control unit 17 activates, in accordance with the content of setting, a predetermined application to be executed after unlock (step S306). Then, the electronic device 100 ends the processing of the iris authentication without the movement pattern.

The authentication processing by the electronic device 100 is executed as described above.

According to the first embodiment, multiple points are sets on the screen such that the order for the multiple points is determined, and the electronic device is unlocked when the change in the exposure amount of the iris while gazing is performed at the points according to this order matches a registered template. In this method, the tendency of the change in the exposure amount of the iris does not depend on a positional relation between the user and the electronic device, and thus the iris authentication may be reliably performed irrespective of the positional relation between the user and the electronic device.

### Second Embodiment

The following describes the second embodiment. In the first embodiment, personal authentication is executed by repeating a combination of the iris authentication and matching processing on the number of feature points of the iris multiple times for the respective gaze points on the movement pattern. In a second embodiment, however, personal authentication is executed by performing multiple times of the iris authentication for the respective gaze points, and thereafter by comparing, only once, a template and the profile of change in the number of feature points during the eye gaze movement along the movement pattern.

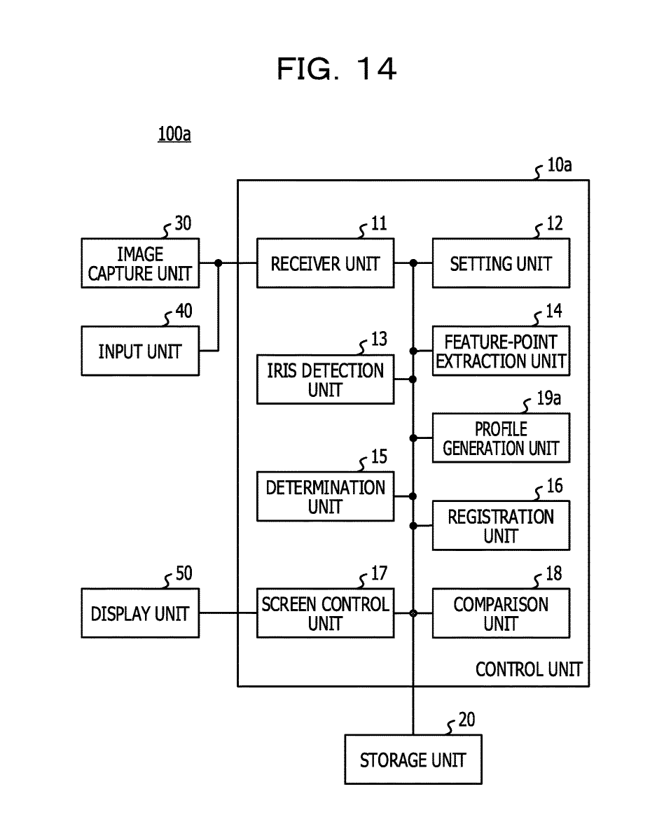

The following describes the second embodiment with reference to FIGS. 14 to 17.

FIG. 14 is an exemplary functional block diagram of an electronic device in the second embodiment. As illustrated in FIG. 14, this electronic device 100a includes a profile generation unit 19a. The profile generation unit 19a acquires the number of feature points for each gaze point by counting the multiple feature points extracted by the feature-point extraction unit 14. Then, the profile generation unit 19a generates a profile indicating the change in the number of feature points by using the number of feature points acquired for each gaze point. Each functional block other than the profile generation unit 19a and a function thereof illustrated in FIG. 14 are same as those in the first embodiment illustrated in FIG. 1.

The following describes processing of registering the authentication information in the second embodiment.

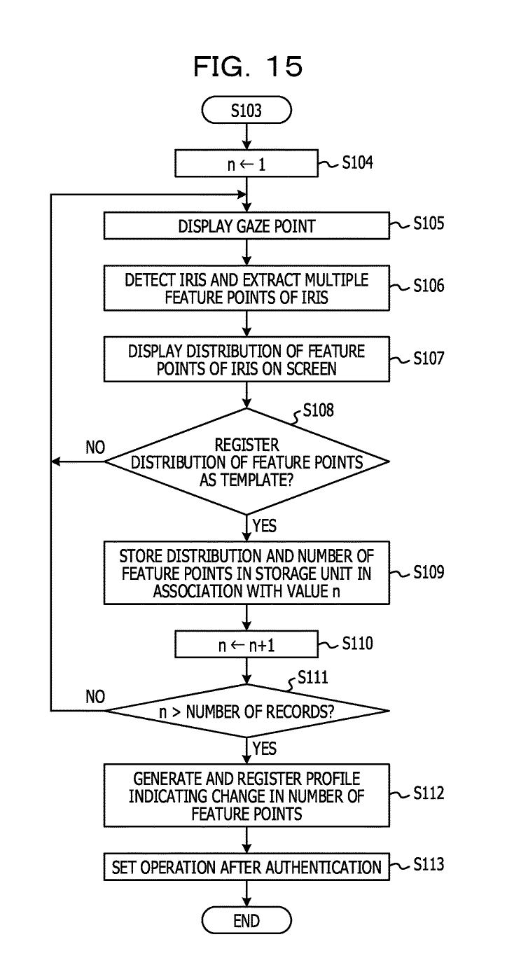

First, processing same as that at steps S101 to S103 illustrated in FIG. 7 is executed. The processing at step S114 and later when the iris authentication by the pattern is not selected with the negative determination (No) in the processing at step S102 are same as those in the first embodiment illustrated in FIG. 11, and thus description thereof will be omitted. After the processing at step S103 is executed with the positive determination (Yes) at step S102, the process proceeds to step S104 illustrated in FIG. 15.

FIG. 15 is a flowchart of an exemplary method of registering the authentication information in the second embodiment. In FIG. 15, any processing identical to that in the first embodiment illustrated in FIG. 9 is denoted by an identical reference sign. The processing at steps S104 to S110 is same as the processing illustrated in FIG. 9, and description thereof will be omitted. The following description starts with the processing at step S111.

At step S111, if it is determined by the determination unit 15 that the value n is not larger than the number of records (No at step S111), the process returns to step S105 so as to continuously acquire new information on the iris. Then, the processing at step S105 and later is executed again. If it is determined the value n is larger than the number of records (Yes at step S111), the profile generation unit 19a generates, by using information on the number of feature points of the iris extracted at step S106, a profile indicating change in the number of feature points during the eye gaze movement along the movement pattern. Then, the registration unit 16 registers the generated profile in the storage unit 20 (step S112).

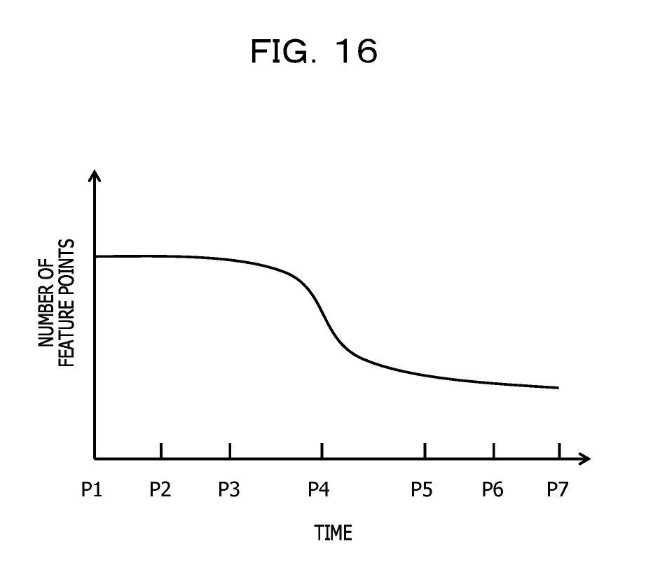

FIG. 16 is a diagram illustrating an exemplary profile of change in the number of feature points. FIG. 16 illustrates a profile corresponding to the movement pattern illustrated in FIG. 4. In FIG. 16, the horizontal axis represents time, and the vertical axis represents the number of feature points. As illustrated in FIG. 16, the number of feature points is substantially fixed from P1 to P3. However, the number of feature points decreases after P3 and becomes substantially fixed again from P5.

In FIG. 15, after the processing at step S112, the setting unit 12 sets operation after authentication (step S113). A method of the processing at step S113 is same as that at step S113 in the first embodiment illustrated in FIG. 9, and thus description thereof will be omitted. Upon completion of the processing at step S113, this series of processing for registering multiple authentication templates ends.

In this manner, in addition to a template of the distribution of the feature points of the iris, the profile indicating change in the number of feature points is registered as a template in the storage unit 20.

The following describes the authentication processing in the second embodiment.

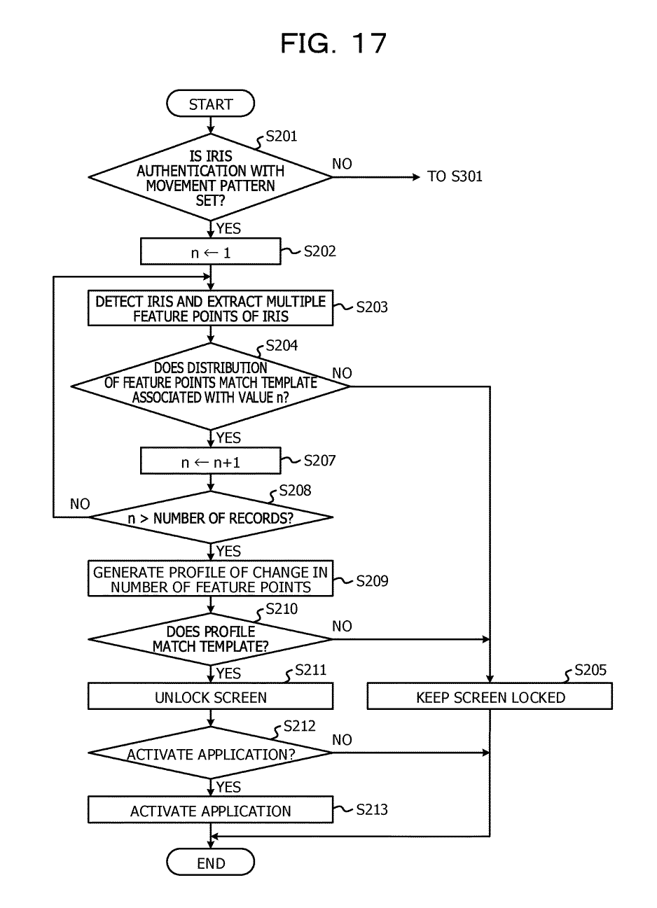

FIG. 17 is a flowchart of an exemplary authentication method in the second embodiment. In FIG. 17, any processing identical to that in the first embodiment illustrated in FIG. 12 is denoted by an identical reference sign.

The processing at step S301 and later when it is determined that the iris authentication with the movement pattern is not set with the negative determination (No) in the processing at step S201 is same as that of the first embodiment illustrated in FIG. 13, and thus description thereof will be omitted. The process from the processing at step S202 to the processing at step S208 after the positive determination at step S201 is same as that of the first embodiment illustrated in FIG. 12, and description thus thereof will be omitted. The following description starts with the processing at step S208.

At step S208, if it is determined by the determination unit 15 that the value n is not larger than the number of records (No at step S208), the process returns to step S203 so as to continuously acquire new information on the iris. Then, the processing at step S203 and later is executed again. If it is determined the value n is larger than the number of records (Yes at step S208), it is determined that the iris authentication repeated for the number of records has ended. Then, the profile generation unit 19a generates a profile indicating change in the number of feature points by using information on the number of feature points of the iris for each gaze point extracted at step S203 (step S209).

Subsequently, the determination unit 15 determines whether the profile generated at step S209 matches a previously registered profile template (step S210). If it is determined the profile generated at step S209 does not match the template (No at step S210), it is determined that the iris authentication has failed, and then the process proceeds to step S205, and the screen control unit 17 keeps the screen locked. Then, the electronic device 100a ends this series of the authentication processing.

If it is determined the profile generated at step S209 matches the template (Yes at step S210), it is determined that personal authentication has been successful, and the screen is unlocked (step S211). Thereafter, the process proceeds to step S212. The processing at steps S212 and S213 is same as that in the first embodiment illustrated in FIG. 12, and thus description thereof will be omitted. Upon completion of the processing at step S213, this series of processing related to personal authentication ends.

The authentication processing by the electronic device 100a is executed as described above.

According to the second embodiment, a profile indicating change in the number of feature points is compared to a previously registered profile template after execution of the iris authentication for gaze point. Then, the electronic device is unlocked when the profiles match each other. This method requests only one execution of the authentication processing based on the eye-gaze detection, and thus, personal authentication may be performed through a fewer number of processes than that of the first embodiment that requests multiple times of execution of the authentication based on the eye-gaze detection.

### Third Embodiment

The following describes a third embodiment. In the first embodiment and the second embodiment described above, the number of feature points is used as an index indicating the exposure amount of the iris. In the third embodiment, however, a relative area of the iris is used as an index indicating the exposure amount of the iris. In the following description of the present embodiment, a ratio of the area of the iris relative to the entire area of an eye in an image is referred to as a “relative area”.

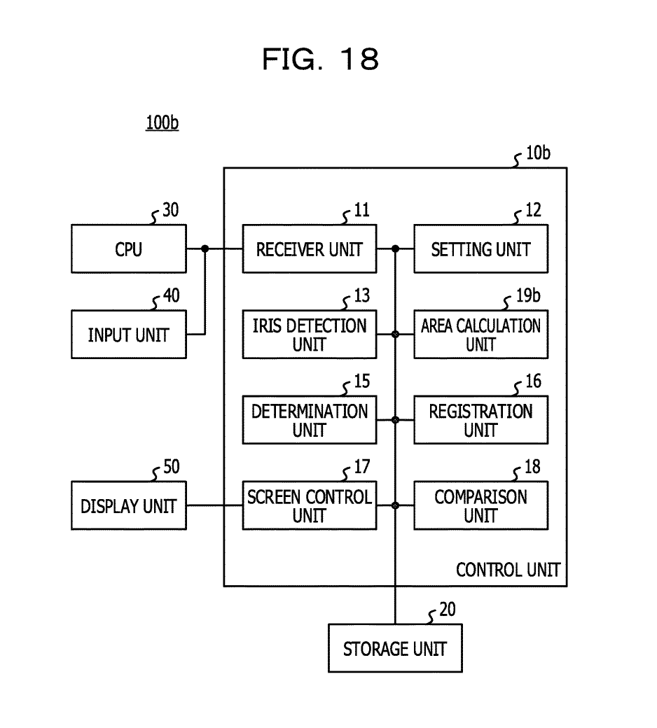

The following describes the third embodiment with reference to FIGS. 18 to 20.

FIG. 18 is an exemplary functional block diagram of an electronic device in the third embodiment. As illustrated in FIG. 18, this electronic device 100b includes an area calculation unit 19b in place of the feature-point extraction unit 14. The area calculation unit 19b calculates a relative exposed area of the iris for each gaze point. The area calculation unit 19b is an exemplary calculation unit. Each functional block other than the area calculation unit 19b and a function thereof illustrated in FIG. 18 are same as those in the first embodiment illustrated in FIG. 1.

The following describes processing of registering the authentication information in the third embodiment.

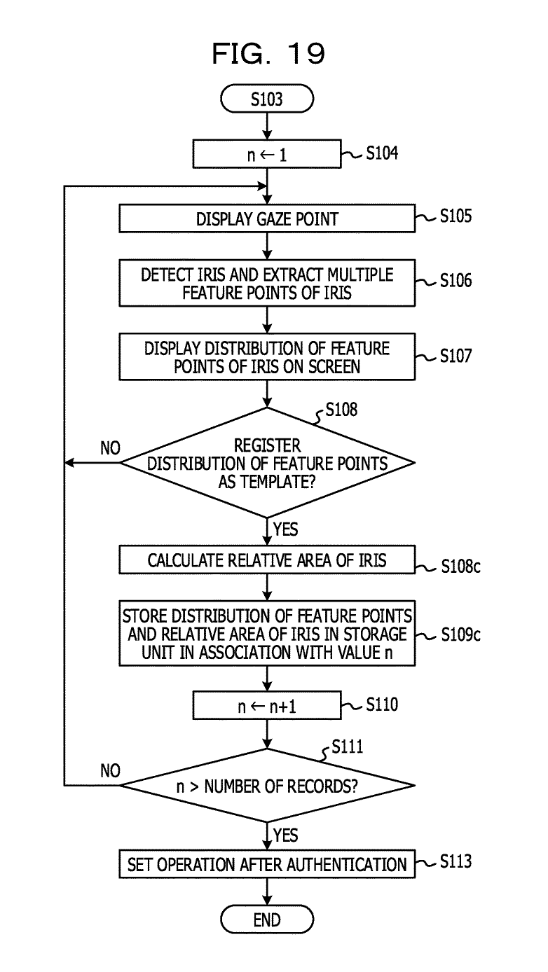

First, the screen control unit 17, the determination unit 15, and the setting unit 12 execute processing same as that at steps S101 to S103 illustrated in FIG. 7. After the processing at step S103, the process proceeds to step S104 illustrated in FIG. 19.

FIG. 19 is a flowchart of an exemplary method of registering the authentication information in the third embodiment. In FIG. 19, any processing identical to that in the first embodiment illustrated in FIG. 9 is denoted by an identical reference sign. The processing from steps S104 to S107 is same as the processing illustrated in FIG. 9, and thus description thereof will be omitted. The following description starts with the processing at step S108.

After the processing at step S107, the determination unit 15 determines whether to register, as a template, the distribution of the feature points based on information inputted by the user through the input unit 40 (step S108). If it is determined not to register the distribution of the feature points as a template (No at step S108), the process returns to step S105 to execute again the processing at step S105 and later. If it is determined to register the distribution of the feature points as a template (Yes at step S108), the area calculation unit 19b calculates the relative area of the iris (step S108c). The relative area of the iris may be calculated by calculating the area of the eye and the area of the iris by using the well-known method of calculating the area of a particular region in an image, and then dividing the area of the iris by the area of the eye.

Subsequently, the registration unit 16 stores the distribution of multiple feature points and the value of the relative area of the iris in association with the value n in the storage unit 20 (step S109c). In this manner, the distribution of the feature points at the n-th gaze point, and the relative area of the iris are registered in advance. The processing at steps S110, S111, and S113 is same as the processing illustrated in FIG. 9, and thus description thereof will be omitted.

The processing of registering a template of the iris used in the authentication processing and the value of the relative area of the iris is executed as described above.

The following describes the authentication processing in the third embodiment.

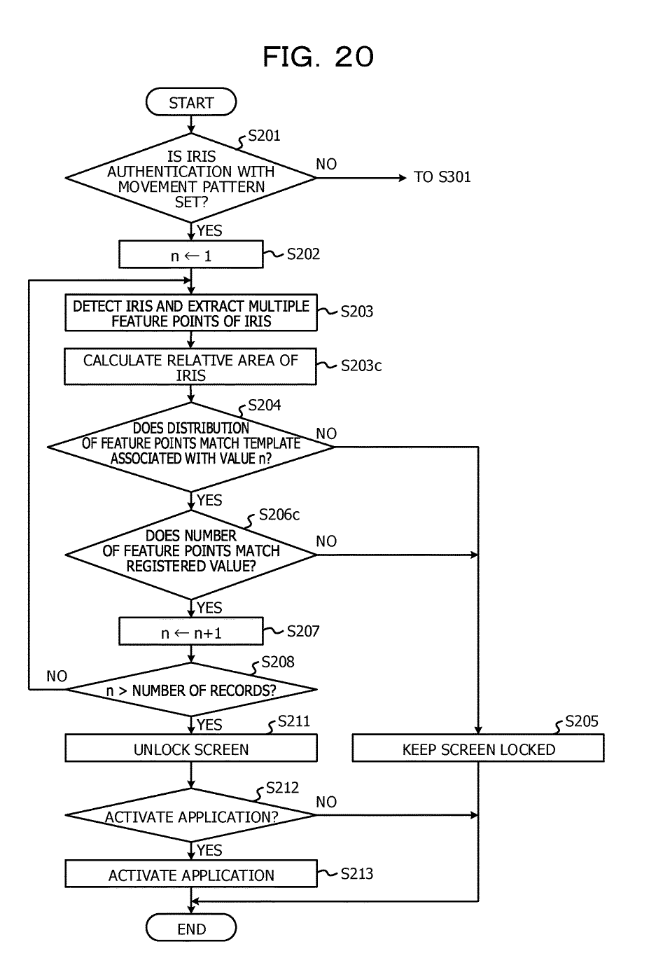

FIG. 20 is a flowchart of an exemplary authentication method in the third embodiment. In FIG. 20, any processing identical to that in the first embodiment illustrated in FIG. 12 is denoted by an identical reference sign.

The processing at step S301 and later when it is determined that the iris authentication with the movement pattern is not set with the negative determination (No) in the processing at step S201 is same as that in the first embodiment illustrated in FIG. 13, and thus description thereof will be omitted. Processing executed at steps S202 and S203 after the positive determination at step S201 is same as that in the first embodiment illustrated in FIG. 12, and thus description thereof will be omitted.

After the processing at step S203, the area calculation unit 19b calculates the relative area of the iris detected at step S203 (step S203c). Similarly to the processing at step S108c illustrated in FIG. 19, a method of calculating the relative area of the iris may employ the well-known method of calculating the area of a particular region in an image.

Subsequently, the determination unit 15 determines whether the distribution of the feature points extracted by the feature-point extraction unit 14 matches a previously registered template of the distribution of the feature points associated with the value n (step S204). If it is determined the extracted distribution of the feature points does not match the template of the distribution of the feature points associated with the value n (No at step S204), it is determined that personal authentication has failed, and the screen control unit 17 keeps the screen locked (step S205). Then, the electronic device 100 ends this series of the authentication processing.

If it is determined the extracted distribution of the feature points matches the template of the distribution of the feature points associated with the value n (Yes at step S204), it is determined that the iris authentication has been successful, and subsequently, the determination unit 15 determines whether the value of the relative area of the iris matches a previously registered value of the relative area (step S206c). At step S206c, if the value of the relative area is not exactly equal to, but is practically nearly equal to the registered value, it is determined that they match each other. For example, it is determined that they match each other if a difference between these values is within a predetermined range.

If it is determined the relative area of the iris does not match the registered value of the area (No at step S206c), it is determined that personal authentication has failed, and the screen control unit 17 keeps the screen locked (step S205). Then, the electronic device 100b ends this series of the authentication processing. If it is determined the relative area of the iris matches the registered value of the area (Yes at step S206c), it is determined that the n-th authentication has been successful. Then, the setting unit 12 sets a new value n to be a value obtained by adding one to the old value n (step S207). Thereafter, the process proceeds to step S208. The processing at step S208 and later is same as that in the first embodiment illustrated in FIG. 12, and thus description thereof will be omitted. Upon completion of the processing at step S213, this series of processing related to personal authentication ends.

The authentication processing by the electronic device 100b is executed as described above.

The area of the iris on an image depends on the distance between the electronic device 100b and the eye, and the area of the iris on the image becomes smaller as the distance becomes larger. The distance between the electronic device 100b and the eye differs among authentications, and it may be impossible to keep the same distance. For this reason, it is not reasonable to register the absolute value of the area of the iris in advance and use the absolute value in comparison.

According to the third embodiment, the relative area is used as an index of the exposure amount of the iris, and the electronic device is unlocked when the relative area of the iris matches a previously registered value of the relative area. According to this method, a substantially identical value may be obtained for an identical user and the same eye opening manner irrespective of the distance between the electronic device 100b and the eye, thereby achieving the iris authentication at high accuracy.

The preferable embodiments of the present disclosure are described above in detail, but the present disclosure is not limited to a particular embodiment, and various kinds of modifications and changes are applicable. For example, in the second embodiment, the profile of change in the number of feature points is compared to a previously registered template after execution of the iris authentication for each gaze point. However, the profile of change in the relative area of the iris may be compared to a previously registered template of the relative area.

An area ratio between the upper and lower parts of the iris may be used as the exposure amount of the iris in place of the relative area of the iris. In calculation of the area ratio between the upper and lower parts of the iris, for example, first, the region of the iris on an image is divided into an upper part and a lower part by a base straight line that passes through the center of the crystalline lens, and then the area of the upper part of the iris and the area of the lower part of the iris are calculated. Thereafter, the area ratio between the upper and lower parts of the iris may be calculated by dividing the area of the upper part of the iris by the area of the lower part of the iris or by dividing the area of the lower part of the iris by the area of the upper part of the iris. According to these methods, a substantially identical value may be obtained for an identical user and the same eye opening manner irrespective of the distance between the electronic device 100b and the eye, thereby achieving the iris authentication at high accuracy.

Face authentication may be added to the personal authentication methods according to the present embodiments so as to provide further improved security.

The scope of the present disclosure includes a computer program that causes a computer to execute a portable terminal device and a control method described above, and a non-temporary computer-readable recording medium that records therein the computer program. The non-temporary computer-readable recording medium is, for example, a memory card such as an SD memory card. The computer program is not limited to that recorded in the recording medium, but may be that transmitted through an electric communication line, wireless or wired communication line, and a network such as the Internet.

All examples and conditional language recited herein are intended for pedagogical purposes to aid the reader in understanding the invention and the concepts contributed by the inventor to furthering the art, and are to be construed as being without limitation to such specifically recited examples and conditions, nor does the organization of such examples in the specification relate to a showing of the superiority and inferiority of the invention. Although the embodiments of the present invention have been described in detail, it should be understood that the various changes, substitutions, and alterations could be made hereto without departing from the spirit and scope of the invention.

What is claimed is:

1. An authentication method executed by a processor included in an electronic device, the authentication method comprising:
setting a plurality of gaze points on a screen of the electronic device such that an order for the gaze points is determined;
capturing a plurality of images of an eye at the gaze points, when the eye gazes at the gaze points according to the order;
detecting an iris from each of the images of the eye;
calculating an exposure amount of the iris in each of the images of the eye; and
releasing restriction of operation on the electronic device, when it is determined that a pattern of the iris agrees with a previously registered template and the exposure amount of the iris agrees with a previously registered value.

2. The authentication method according to claim 1,
wherein the gaze points are edge points of a movement pattern obtained by connecting the gaze points.

3. The authentication method according to claim 1, further comprising
displaying at least one of the gaze points on the screen based on the order.

4. The authentication method according to claim 3,
wherein every time one of the gaze points is displayed on the screen, a message for prompting a user of the electronic device to gaze at the one gaze point is outputted.

5. The authentication method according to claim 3,
wherein the displaying includes displaying, on the screen, the plurality of gaze points and information on the order for the gaze points.

6. The authentication method according to claim 5,
wherein the displaying includes displaying an arrow on the screen, the arrow indicating the order by passing through positions of the gaze points.

7. The authentication method according to claim 1,
wherein the calculating includes:
extracting multiple feature points from the iris in each of the images of the eye, and
calculating the number of the extracted feature points.

8. The authentication method according to claim 1,
wherein the calculating includes calculating a relative area indicating a ratio of the area of the iris relative to the area of the eye in each of the images of the eye.

9. The authentication method according to claim 1, wherein the calculating includes:
dividing a region of the iris in each of the images of the eye into an upper part and a lower part by a predetermined base straight line, and
calculating a ratio between the area of the upper part of the iris and the area of the lower part of the iris.

10. An electronic device, comprising:
a memory; and
a processor coupled to the memory and configured to:
set a plurality of gaze points on a screen of the electronic device such that an order for the gaze points is determined,
capture a plurality of images of the eye gazing at the gaze points, when the eye gazes at the gaze points according to the order,
detect an iris from each of the images of the eye,
calculate an exposure amount of the iris in each of the images of the eye, and
release restriction of operation on the electronic device, when it is determined that a pattern of the iris agrees with a previously registered template and the exposure amount of the iris agrees with a previously registered value.

11. A non-transitory computer-readable recording medium storing a program that causes a processor included in an electronic device to execute a process, the process comprising:
setting a plurality of gaze points on a screen of the electronic device such that an order for the gaze points is determined;
capturing a plurality of images of the eye gazing at the gaze points, when the eye gazes at the gaze points according to the order;
detecting an iris from each of the images of the eye;
calculating an exposure amount of the iris in each of the images of the eye; and
releasing restriction of operation on the electronic device, when it is determined that a pattern of the iris agrees with a previously registered template and the exposure amount of the iris agrees with a previously registered value.
